(19) United States
(12) Patent Application Publication
(10) Pub. No.: US 2015/0266736 A1
(43) Pub. Date: Sep. 24, 2015

(54) Rust preventing liquid solution for disc brake rotors

(71) Applicant: Ryan C. Jacobs, Butler, NJ (US)

(72) Inventor: Ryan C. Jacobs, Butler, NJ (US)

(21) Appl. No.: 13/971,780

(22) Filed: Aug. 20, 2013

(51) Int. Cl. C01B 21/50; B08B 3/08; F16D 65/12

(52) U.S. Cl. CPC C01B 21/50; F16D 65/12; B08B 3/08

(57) ABSTRACT

A method for preventing rust from forming on disc brake rotors or braking components after cleaning wheels and braking systems. This method would include the procedure of applying a rust preventing liquid solution or mixture to prevent a vehicle's disc brake rotors and braking components from rusting after the outside of a vehicle and or the vehicle's wheels and brakes are cleaned with water and or in conjunction with cleaning products.

### TECHNICAL FIELD

Certain embodiments of the present disclosure generally relate to rust prevention and, more particularly, to protect swept areas of disc brake rotors or braking components from corrosion after they get wet or are cleaned.

### BACKGROUND

The disc brake rotors of a vehicle are easily susceptible to rusting since the disc brake rotors are usually made of a cast iron. This particular problem often occurs when the car is washed or cleaned with water and or in conjunction with cleaning products. Consequently, during this drying period, since the disc brake rotors are exposed to water, it is almost certain that disc brake rotors will become rusted as the disc brake rotors are allowed to dry.

Because of the rusted disc brake rotors, the vehicle's initial braking performance can be affected, the initial braking noise levels heard inside and outside of the vehicle can be affected and it causes a brake dust coating of rust on the vehicle's wheels after washing or cleaning the outside of a vehicle and or the vehicle's wheels and brakes.

Unfortunately, this problem is felt by vehicle owners or vehicle detailing businesses who drive the vehicle long enough to apply the vehicle's brakes to sweep the rust off of the vehicle's disc brake rotors. This brake dust coating of rust caused by the excess build-up of rust on the vehicle's disc brake rotors can require vehicle owners or vehicle detailing businesses to re-clean or wipe down the vehicle's wheels and braking components to remove the initial brake dust coating of rust, For detailing businesses this can cause a liability concern when driving the customer's vehicle long enough to apply the vehicle's brakes to sweep the rust off of the vehicle's disc brake rotors.

The formation of rusting of disc brake rotors is not a problem when the vehicle is in normal use, since the disc brakes are wiped by the brake pads during braking. The disc brake rotors can however rust when the outside of a vehicle and or the vehicle's wheels and brakes are washed or cleaned with water and or in conjunction with cleaning products and the disc brake rotors are allowed to dry, for example, more than 1 minute.

In order to keep the disc brake rotors and braking components from rusting, some attempts solve the problem have included the use of corrosion-resistant paint and zinc coatings on the un-swept surface of the disc brake rotors. Applying these forms of rust prevention onto the swept surface of the disc brake rotors can decrease braking ability of the vehicle because the existent coefficient of friction is reduced. Consequently, if the vehicle is driven with these forms of rust preventing treatments left on the swept surface of the disc brake rotors, it becomes very dangerous for the driver to operate the vehicle because of the decrease in friction between the brake pad and brake rotor. On the other hand, if a rust preventive substance on the swept surface of the disk brake rotors did not decrease the braking ability of the vehicle or reduce the friction between the disc brake pad and disc brake rotor, said invention would be safe for the driver as it would not leave any residue, film or layer between the disc brake pad and disc brake rotor.

The objective of the present invention is to provide a rust preventing solution capable of keeping the disc brake rotors from rusting after the vehicle has been cleaned, without affecting the braking ability of the vehicle. It has been proposed to overcome this problem by applying a rust preventing liquid solution or mixture containing but not limited to the active ingredient Sodium Nitrite to a vehicle's swept areas of a disc brake rotors to keep them from forming rust. This rust preventing solution or mixture typically dries quickly without any leftover residue on the disc brake rotor surfaces. Any leftover residue that may form would be fully removed immediately within the first typical application or use of the vehicle's braking system. The invention also provides a disc brake rotors treated in accordance with the method of the invention.

### SUMMARY OF THE DISCLOSURE

Certain embodiments provide a method for preventing rust from forming on disc brake rotors or braking components after cleaning wheels and braking systems. This method would include the procedure of applying a rust preventing liquid solution or mixture to prevent a vehicle's disc brake rotors and braking components from rusting after the outside of a vehicle and or the vehicle's wheels and brakes are cleaned with water and or in conjunction with cleaning products.

Certain embodiments relate to a vehicle's disc brake rotors and braking components, and in particular to protecting them from corrosion or the formation of rust on swept areas of the disc brake rotors after they get wet.

Certain embodiments provide a method for preventing rust from forming on vehicle disc brake rotors and braking components after getting wet and to prevent the vehicle wheels from collecting a dust layer made up of rust swept off of the rotor face during initial driving after washing the vehicle.

Certain embodiments provide a method of to provide a rust preventing solution capable of keeping the disc brake rotors from rusting after the vehicle has been cleaned, without affecting the braking ability of the vehicle.

Certain embodiments discuss a liquid solution or mixture containing but not limited to the active ingredient Sodium Nitrite may be applied by means of spraying or wetting the swept areas of disc brake rotors and braking components after the outside of a vehicle and or the vehicle's wheels and brakes are washed or cleaned with water and or in conjunction with cleaning products.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only typical embodiments of this disclosure and are therefore not to be considered limiting of its scope, for the disclosure may admit to other equally effective embodiments.

FIG. 1 illustrates an example vehicle disc brake rotor, braking components and wheel, in accordance with certain embodiments of the present disclosure.

### DETAILED DESCRIPTION

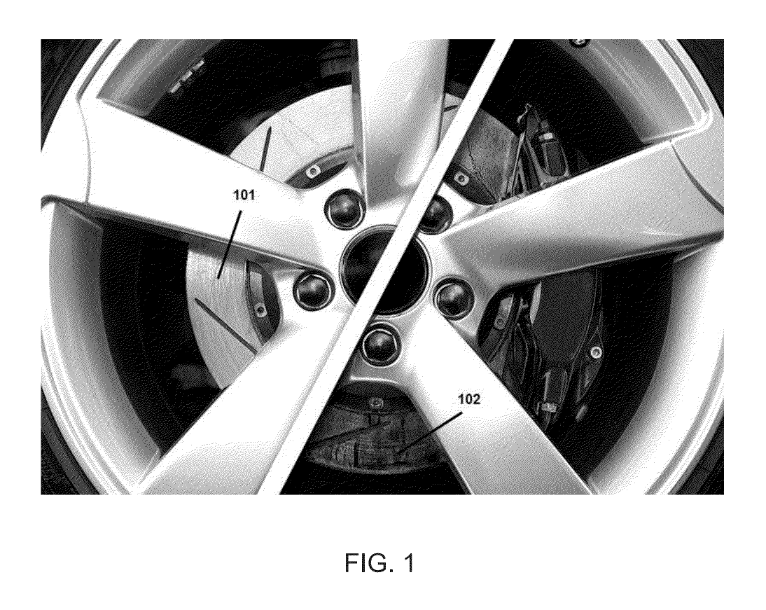

FIG. 1 illustrates a vehicle disc brake rotor, braking components and wheel where the left half of the brake rotor is treated with rust preventing liquid solution or mixture according to the present invention.

According to the present invention, it is possible to keep the disc brake rotors from rusting after the vehicle has been cleaned, without affecting the braking ability of the vehicle. It has been proposed to overcome this problem by applying a rust preventing liquid solution or mixture containing but not limited to the active ingredient Sodium Nitrite to a vehicle's swept areas of a disc brake rotors to keep them from forming rust. This rust preventing solution or mixture typically dries quickly without any leftover residue on the disc brake rotor surfaces. Any leftover residue that may form would be fully removed immediately within the first typical application or use of the vehicle's braking system. The invention also provides a disc brake rotors treated in accordance with the method of the invention.

1. A method for preventing rust from forming on disc brake rotors or braking components when cleaning wheels and braking systems.

2. The method of claim 1, wherein a self drying liquid solution or mixture containing but not limited to the active ingredient Sodium Nitrite may be applied by means of spraying or wetting the swept areas of disc brake rotors and braking components after the outside of a vehicle and or the vehicle's wheels and brakes are washed or cleaned with water and or in conjunction with cleaning products.

3. The method of claim 1, wherein a self drying liquid solution or mixture containing but not limited to the active ingredient Sodium Nitrite may be applied by means of spraying or wetting the swept areas of disc brake rotors and braking components before the outside of a vehicle and or the vehicle's wheels and brakes are washed or cleaned with water and or in conjunction with cleaning products.

4. A disc brake rotor which has been treated in accordance with the method as claimed in any one of claims 1 to 3.
